(19) United States
(12) Patent Application Publication
(10) Pub. No.: US 2012/0182827 A1
(43) Pub. Date: Jul. 19, 2012

(54) PROCESS FOR CONTINUOUS DRY CONVEYING OF CARBONACEOUS MATERIALS SUBJECT TO PARTIAL OXIDIZATION TO A PRESSURIZED GASIFICATION REACTOR

(76) Inventor: Faramarz Bairamijamal, Gaithersburg, MD (US)

(21) Appl. No.: 13/261,207

(22) PCT Filed: Sep. 9, 2010
(86) PCT No.: PCT/US2010/002482

§ 371 Date: Mar. 8, 2012

(30) Foreign Application Priority Data
Sep. 24, 2009 (EP) 09012157.5

(51) Int. Cl. B01F 15/02; B01F 15/04; B01F 15/06

(52) U.S. Cl. 366/149; 366/182.3; 366/162.1; 366/151.1

(57) ABSTRACT

The present invention demonstrates a continuous process for dry conveying of powdered coal either a blend of carbonaceous material subject to partial oxidization whereby the conveying feed will be transferred via a suitable conveyer from an atmospheric silo to a or a number of extruder's LP Feeder Vessel and be fed over extruder's inlet chute in continuo to a or a number of extruder(s), in which the dry feed material will be densificated along the compression zone of that extruder up to high pressure and will be discharged over outlet chute into a downstream said First Pressurized Vessel, wherefrom the feeding precursor will be transported via a or a number of in series pressurized tubular-drag conveyor to the said Second Pressurized Vessel, which is equipped with one or more Reactor Feeding Unit(s), referred to Splitter(s), each one consisting of a Star Valve, Reactor-Feed-Line and a said Injection-Line for pneumatic conveying individually, whereby the feed carbonaceous material will be exposed to with injection gaseous media (saturated steam, superheated steam, inter gases, natural gas, N2, CO2, purge gas from synthesis section of ammonia, methanol plant, purge gas from PSA of hydrogen purification section, hydrogen or a blend of those gaseous media in any composition) by the formation of any pneumatic bulk conveying mechanism into a downstream pressurized reactor, preferably a gasification reactor, wherein the transported precursor will be converted chemically under high temperature and elevated pressure via partial oxidization reactions to process gas, slag and ash.

### CROSS-REFERENCE TO RELATED APPLICATION

The present application is related in general subject matter to European Patent Application EP 09 012 157.5 filed on Sep. 24, 2009 entitled “Process for continuous dry conveying of carbonaceous materials subject to partial oxidization to a pressurized gasification reactor”.

### FIELD OF THE INVENTION

The present invention relates to a process for conveying of precursors material for partial oxidization in pressurized reactor, in particular to gasification reactor. The present invention relates also to a device invention pertaining to high pressure bulk solid densification device.

The obtained row process gas from gasification reactor through chemical partial oxidization can be prepared in sequel either for various chemical syntheses or be applied for power generation by use of gas turbine. The processing with the gas turbine opens both the most attractive way for CO2 sequestration and also environmentally benign power generation compared with other alternatively conventional power generation methods.

### BACKGROUND OF THE INVENTION

In gasification technology carbonaceous precursor materials i.e. coal, oils, natural gas and similar materials will be converted by chemical partial oxidization under high temperature and pressure to process gas primarily consisting of CO and H2.

In order to feed those materials into the pressurized reactor, the precursors have to be elevated up to higher pressure as higher as the prevailing reactor pressure. The feeding pressure of those materials is usually in the margin of 2 till 5 bar over the privileging reactor pressure before the precursors enter into the reactor.

While the pressure elevation of gaseous precursors can be readily carried out by the way of compressor or the pressurization of liquid feed materials via pump, the pressure elevation of dry bulk solid materials arouse serious technical troubles for transformation of precursor to the reactor by actual state-of-the-art method. Basically there are two processes commonly in use, aimed at to the feeding of bulk solid materials by pressure elevation into gasification reactor.

One of applied process performs the preparation of coal slurry, composed of coal powder and other oxidizing materials with a liquid i.e. oil or utmost water. The prepared slurry will be pressurized by pumping and injected into the reactor in sequel.

Because large quantity of coal is to be fed for gasification reactor, the use of water as carrier media in slurry feeding is almost applied in the gasification technology. The most disadvantage of water as carrier media relates to the considerably reduction of thermal reactor performance. The injected coal impinged by water reduces the required high reactor temperature due of vaporization of accompanied water significantly. In order to compensate the balance by keeping reactor at high temperature, additional part of the fed coal has to be totally oxidized by combustion reaction to undesired CO2. The combustion reaction leads inevitably to lower reactor yield associated with the fed carbon mass flow due the formation of undesirable CO2 in lieu of intended CO formation.

In order to avoid the co-fed water attendance to the reactor (along the coal feeding), there is implemented a discontinuous intermittently dry coal feeding method.

In that dry conveying process, the precursor (coal powder or similar materials in various particle sizes and shapes briskets, pellets, etc.) will be discharged from atmospheric hopper intermittently to a number of lock hoppers operating in turn. The charging to each lock hopper is designated by individually step-by-step processing in sequel tact. Once one lock hopper is filled up with the precursor, the hopper has to be closed by valves and pressurized in the next tact by the way of a said carrier gas; which acts as pressurizing media. The pressurization will be performed automatically by time/pressure control tact. After pressure stabilization the lock hopper discharges the fed material via number of valves to a pressurized feeder vessel (said “Pressurized Surge Hopper”) in the sequel tact. Once the discharge tact has been performed, the discharge valves and pressure equalization valves connecting to the pressurized surge hopper will be closed. In the next tact the depressurization of lock hopper takes place in a time controlled manner. Finally the charging valve opens the way to the attributed atmospheric hopper so that the charging tact can be repeated back from the first cyclic tact. The process is designated with a number of tact wise working lock hoppers (each one usually attributed to an atmospheric hopper) in order to compensate the incurring various lag times necessary for tact procedure. The feeding process downstream of pressurized surge hopper can be regarded nearly as a continuous process.

Therefore the lock hoppers have to cape a large quantity of feeding material in a short time for filling and discharge tact. Thus lock hopper tact time is to be short, that leads to an unduly large size of hoppers and related equipment causing higher investment cost under intermittently operation. The size of hoppers associated with the rhythmic pressurization/depressurization leads imperative to the point, that the lock hoppers are to be designed according to Cyclic Pressure Change Regulation. This condition increases the costs in an added measure as well.

The quick tact operation of lock hopper feeding system requires a great number of remote operating OPEN/CLOSE valves and pipes in a great diameter bore in addition. Respectively all connecting valves are to be designed also according to Cyclic Pressure Change Regulation in the field of lock hopper section.

Another significant disadvantage of this process is hallmarked with a great number of remote controlled valves operating in OPEN/CLOSE positions pertaining to the actual tact. That marks the entire process as failure prone and requires adequate process control personnel maintaining the entire equipments above.

The entire extent of remote control valves comprises a great number of time and measurement, transducers, controlled devices including control loop all subject of integration in the plant DCS. In order to attain more reliability in process control operation, those measurements and transducers shall be provided in 2 of 3 or 2 of 4 vote redundantly as a measure for precaution for compensation of malfunction and avoidance of process interruption.

The feeding process acting in series of tact by the lock-hopper-system has been originally considered for experimental rig or test rig only, because of associated low investment required for a test rig. Surprisingly, due lack of technically alternative process, there are facilitated a lot of commercial plants employing that process in the commercial plants up to actual time.

That is obvious that the transferring of primarily laboratory rig into commercial plants leads to technical immensely extent of efforts. Thereof for the conversion of a large amount of feeding material there are a great atmospheric hopper, a number of intermittently operating lock hoppers, a large pressurized surge hopper are needed for the coal feeding section. In conjunction to that equipment there are a great number of remote valves, measurement devices as well as charging, discharging and pendel pipes necessary.

In added disadvantage, as a result from the large size of equipment necessary for the handling of precursor in large size silos, there is imperative to provide a carrier gas keeping coal in steady move and fluidization in the hoppers. This precaution measure is necessary in order to undermine the jam up or plugging of coal within the hoppers. For that circumstance there is a need for high flow of inert gas necessary for silos as well as for intermittently pressurization of lock hoppers.

The dry conveying of feeding material requires also a high quantity of inert gas necessary for pneumatic conveying of bulk material from surge hopper to the reactor. Aside of extraordinary efforts in pursuant to above outlined circumstances in the coal feeding plant island, there are also other impacts taking place in the gasification reactor, all gas related reactor downstream plant islands and equipment including coal handling inert gas related equipment (compressor, intercoolers and the size of gas buffer tanks). These impacts are termed as sub-sequel or disguised factors which ultimately influence the economy and feasibility of a gasification site essentially.

In order to keep a stable operation regime for pneumatic conveying of bulk material, it is imperative to provide a fluidization regime of coal in pressurized surge hopper (at least in lower compartment of surge hopper) and convey the feeding material by low specific ratio of coal mass flow to inert conveying gas mass flow. The processing is designated by that ratio, which unveils the actual mechanism of coal conveying process spreading from dilute pneumatic conveying with the telltale margin of:

and to
μ=3 to 10 kg (Product)/kg (gas)
μ=10 to 30 or higher kg (Product)/kg (gas)
   characterized for pressurized dense flow phase conveying. Higher ratio of coal mass flow to inert conveying gas mass flow is referred to ultra dense coal conveying mechanism. The lower the specific ratio of coal mass flow to inert conveying gas mass flow, the more stabile will be the operation of entire coal conveying into the reactor according to the state-of-the-art lock hopper system. But, in turn, the lower μ ratio, the higher roars the extent of adverse technical and economic investment cost impact taking place in the reactor, all reactor downstream plant islands and equipment including the utility fluidizing and conveying gas equipment i.e. compressor, intercoolers and the size of gas buffer tanks too.

The sub-sequel adverse impact for the investment costs by low μ ration skyrockets in particular the footprint of Acid Gas Removal Unit, if the plant is supposed to produce SNG (Substituted Natural Gas) by availing CO2 as fluidizing and conveying carrier gas.

For both purposes (fluidizing gas within the pressurized surge hopper as well pneumatic coal conveying to reactor) a large scale compressor is needed. Therefore the entire process comprises a great sized compressor utilizing the demand of inert gas (mostly carried out by use of nitrogen, a by-product of air separation unit). The compressor requires apparently high energy consumption and maintenance. It is obvious that the compressor needs also gasometers as cushion vessel due of fluctuations in gas consumer silos. Because the employed hoppers are operating in different pressure levels, different cushion gasometers have to be installed in order to avoid surging trip of compressor.

Usually the inert gas compressor can not be installed redundantly because of high investment and maintenance. The trip of inert gas compressor leads inevitably to a outage of entire plant. The re-start of such plant is associated with conjunction of a number of releases and permissive of interlock system.

In continuo, the all equipment requires a large demand on place and steel structure.

It should be highlighted that the entire extent of high costs and technical effort, outlined above will be considerably exacerbated, if low ranked coal is to be fed to the plant compared with high ranked coal.

Since the low ranked coal is having a high impurity constituent as much as upto 40 weight % or more, which does not contribute to chemical partial oxidization reactions, the total mass throughput of feeding low ranked coal precursor increases for certain plant output performance compared with same performance by use of high ranked coal. Therefore the total investment cost for the coal feeding Plant Island for feeding of low ranked coal is significantly higher than those plants fed with high ranked coal under same plant output performance.

Because the dry coal feeding island of a gasification plant imposes one of most crucial and expensive plant section, the state-of-the-art feeding section rules one of most decisively point in realization or demise of a plant investment, aimed at to be installed in regions or countries having abundant low ranked coal. The similar facts are also taking place, if low heat value material i.e. biomass is to be considered as primary precursor or as a co-feed in a blend of precursors.

The present process invention aims also at to a viable technical way which can support the realization of gasification plants for low ranked coal and biomass material at an economically reasonable extent.

### First Temptations to Address the Need for Viable High Pressure Feeding System

In order to mitigate or solve the troubles associated with dry feeding there are some systems conceived of with considerable restrictions and restrains from practicability point of view.

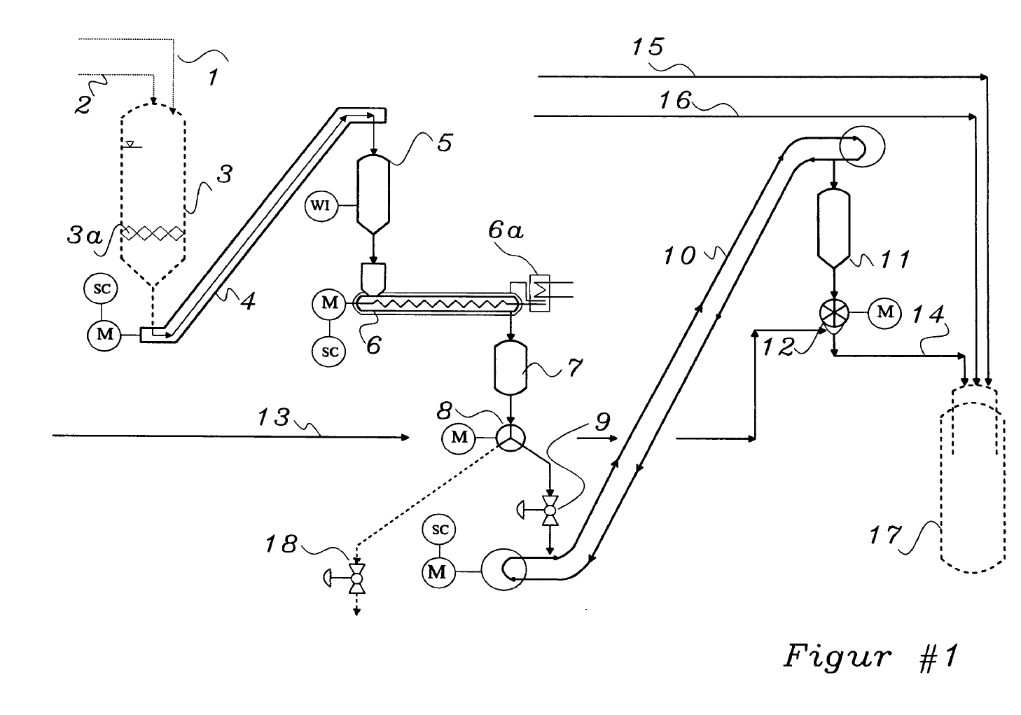

The DE 10 2006 039 622 A1 registered on Aug. 24, 2006 (registered under PCT/EP2007/058034 filed Aug. 2, 2007) trys to accomplish the densification of feeding biomass material through a so called Plug-Screw-Conveyor where the feeding material will be displaced from atmospheric LP section by the way of star valve into a pressurized inlet chamber of a screw conveyor and plugged together before it will be discharged into a moving bed gasifier directly without any measure preventing reflux of gaseous media from gasifier and also over the star valve back to LP sections (FIGS. 1-3). The much complicated process involving great number of equipment can unfortunately perform ultimately a final outlet pressure of maximum 5 bar suitable for biomass gasification only. Higher outlet pressure can not be performed by the way of crew conveyor impinged with gaseous N2 or CO2 media. This process can be applied ultimately for biomass moving bed gasifier or fluidizing bed gasifiers only, because the densified clumpy material will be discharged directly into the reactor and shall crushed to lower parts inside of the gasifier. Other gasifiers employing in large scale plant and operating at high pressure (usually over 40 to 100 bar) can not be addressed by that process beside of other difficulties in sealing and contentment of applicable standards for handling of hazardous bulk solid and gaseous process media.

The DE 10 2008 012 156 A1 (registered on Mar. 1, 2008) admits several problem with screw conveyor but also indicates that a screw conveyor is not able to perform pressurization of feeding material required for commercial gasification plant. The application indicates the ability of screw conveyor as transferring device without any pressure gradient for biomass. A star valve is applied here also as displacing device for biomass which isolate the pressurized inlet section of that screw conveyor from LP section. The outlet pressure of biomass shall be over 2 bar, further specification is not revealed in that patent application. The application implicit the addition of water added to the biomass as sealing agent. In pursuant to this and also the aforementioned patent applications, the great dangerous case encountering with reflux of hazardous gaseous media from reactor (very toxic CO and explosive H2) could not be solved by directly connected screw conveyor to the reactor. The pressurized clumpy biomass or coal material can not provide the safe operation of the suggested isolated gate valve in case of jam-up of feeding material or in case of emergency shut-down of plant.

The US 2006/0243583 A1 (registered on Apr. 29, 2005) known as PWR pump employs in an advanced technology a coal slurry high pressure feeding by invention of a new pump system developed from the scratch. The system provides remedy in feeding of a concentrated coal slurry which will be discharged in a large size Feeder Vessel wherein the slurry is to be dried by addition of a gaseous media into that pressurized hopper. The drying shall be accomplished under fluidizing bed of coal. The dried coal along with a large amount of surplus gaseous N2 or CO2 shall be conveyed into the reactor by the way of ultra dense flow mechanism. This entire system involving great number of equipment, compressor and other equipment performs finally mitigation to the state-of-the-art lock hopper system only.

These serious troubles have led to the conclusion, that in all commercial gasification plant the intricate lock hopper system are installed or are planned to be installed in future plants.

### SUMMARY OF THE INVENTION

The present invention represents a practicable viable process for high pressure conveying of partially oxidizing materials to a pressurized reactor in a reasonable technical as well as economically extent. This purpose will be inventively resolved according to the claim 1. The invention is pertaining to a process for continuous high pressure dry conveying of feed materials for the partial oxidization in a pressurized reactor, in particular a gasification reactor, whereby the feeding material discharging from an atmospheric hopper is fed to at least one extruder whereof the feeding material will be densified through the compression zone of the extruder up to a pressure above the prevailing operation pressure of the gasification reactor.

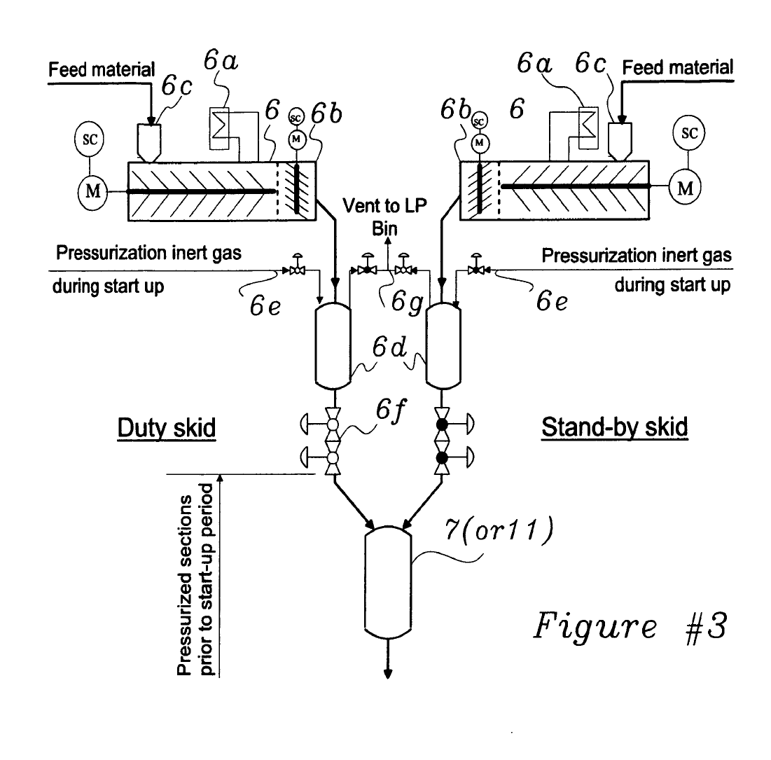

The invention relates also to a device for high pressure densification of dry bulk solid material according to FIG. 3 consisting of a LP Feeder Vessel, an special extruder with rotation controlled electric propulsion (6), with intense cooling circuit 6a, LP or atmospheric inlet chute (6c), pressurized outlet chute (6d) with connection to pressurization gas (6e) and vent (6g), nibbler (6b) and a pressurized vessel for discharge of densified re-powdered free flowing bulk solid material.

As the feeding material subject to the high pressure conveying can be regarded coal dust, coal powder, granulated or pellets of various carbonaceous oxidizing materials in any blend i.e. different kind of coal, residual of refineries like tar, residual of petrochemical refineries pet coke, organic carbonaceous residual wastes of chemical industry, dried powdered biomass, wood chips in various kind, dried powdered black liquor of pulp and paper industry or any other sustainable carbonaceous precursors appropriate for partial oxidization.

The aforementioned extruder serves as a pressure elevation device, which operates like a screw conveyer propels forward the material and pressurize those to a densified feed before discharges that thru a discharge nozzle. The extruder is usually designated with a screw shaft which is embedded in a cylindrical housing and conveys and pressurizes the carbonaceous material by steady rotation movement. The inner diameter bore of the extruder housing is typically equal or comparable with the diameter of the screw shaft. The shaft is either directly coupled with the engine or coupled over a gear box (extruder gear box). The carbonaceous material is fed usually in one side over a funnel hopper downward into the intake nozzle. At the other end of device the discharge nozzle is performed at the bottom of those extruders either directly or over discharge chute.

The screw shaft passes typically in three rotating zones, those of them is designated to employ different tasks. The intake zone is considered in the first part of the extruder. In this section, said intake zone, the take in of the feeding good, is performed; where the conveying is characterized by propelling of material. In the next zone, the feeding good will be compressed by densification of bulk solid up to design pressure required by downstream units of the feeding island. Through the compression zone, the feeding material will be forced for instance by the declining screw dept whereby the compression and densification will be accomplished up to desired output pressure. Downstream of that zone, the discharge section takes place; where the re-powdering of eventually agglomerated clumpy material along the compression zone takes place. This section of extruder (i.e. through an integrated nibbler) crushes the curse agglomerates back to friable powder form ready for further conveying.

The inventively intended extruder for pressurization and densification of feed material can be built up for instance as a single-shaft extruder (with extensively similarity to screw conveyor), double-screw shaft extruder (co-rotating or counter-rotating), multi-shaft extruder, cascade-extruder or as a differential extruder. Through the single shaft screw extruder (as well the co-rotating double shaft screw extruder) the pressurization of powdered material is performed primarily by friction and densification by the way of rotating shaft, which moves the bulk tightly in the declining conveying void volume supposed between the screw dept and housing wall of extruder. This extrusion mechanism is termed Friction Conveying. The rotating gyro-moving bulk along the shaft direction expires a highly densification and pushed down to the discharge funnel. By use of double-shaft extruder the privileging mechanism is termed as Stimulation Conveying.

The present invention represents a viable continuous high pressure conveying of dry material, in particular coal powder, into coal gasification reactor procuring for the partial oxidization and generation of process gas (recently termed to mistakenly as syngas) in sequel. Thereby the invention is pertaining to a continuous high pressure process for conveying of dry coal powder either a blend of carbonaceous materials subject to partial oxidation; whereby the feeding good will be discharged from an atmospheric hopper by the way of a suitable conveyer to a or a number of extruder's feeding vessel, wherefrom the powdered feed will be taken in to a or a number of extruder(s), where along the compression zone of that extruder the densification of feeding good will be carried out and the pressurized feed will be discharged either directly in the first pressurized vessel installed downstream of extruder(s) or over a discharge funnel upstream of that pressurized discharge vessel.

The aforementioned feeding material from the first pressurized vessel will be put in optionally to pressurized tubular drag conveyor downstream of the so called first pressurized vessel. The tubular drag conveyor (either one of them or a number of tubular drag conveyor installed in a series arrangement), will transport the feeding material to the second pressurized vessel. The second pressurized vessel will be installed close to the reactor. Each second pressurized vessel is designated with one or a number of Feeding-Line-Unit(s) consisting of a star discharge valve, a Reactor-Feeding-Line and an Injection-Line individually. By use of a suitable inert injection gas (saturated steam, superheated steam, any kind of inert gaseous media, carbon dioxide or natural gas or a blend of those in any desirable blend and volumetric ratio) the discharged reactor feeding material will be transferred into the reactor by the entrained pneumatic conveying flow mechanism. That carbonaceous material will be converted in the reactor under high pressure and temperature to process gas (also termed as Syngas), ash and slag. Depending on the applicable installation standards, shut off valves, slam shut down valves and isolating valves are performed in each section of Feeding-Line-Unit, injection and also reactor feeding line in pursuant to pertinent standards.

As a measure for flexibility of the material subject to partial oxidation, the feeding good can consist of coal powder in any kind and particle size distribution containing of moisture from 0.1 till 25% by weight. Preferably the invention is related to an atmospheric interim hopper, which will be suitably installed downstream of milling station.

The feeding material from that milling station will be transferred by the way of common conveyer i.e. screw conveyer, band conveyer to that atmospheric day bin hopper.

Advantageously the extruder can be fed with other appropriate carbonaceous material i.e. petroleum coke (Petcoke), coal granulates, hydrocarbon granulates or additives in any blind ratio and in a temperature margin of 5° C. to 100° C., which will be fed into the extruder under inert gas cushion i.e. N2, CO2 or else, subject to conveying for partial oxidation in a pressurized gasification reactor.

The process can be performed by use of an extruder in a single stage or in multi stage(s), which can be installed eventually in series of appropriate extruder types; and which performs the compression of bulk solid—either with intercooling of carbonaceous material or without intercooling—up to a discharge pressure between 0.1 to 300 bara whereby the final discharge pressure of extruder will be over 0.1 to 20 bara over the prevailing pressure in the downstream vessel(s), tubular drag conveyor and the gasification reactor.

In further advantage the process shall be carried out in a way that the accruing friction heat of bulk solid can be diverted from the feed material along the compression zone of extruder indirectly through cooling circuit by application of cooling circuit water, coolant media or refrigerating coolant, exchanged over the jacket cooling coils of extruder and/or optionally through the cooling extruder shaft. The cooling procedure is to be executed in a manner that the carbonaceous material can be kept within a margin of temperature between 20° C. and maximal 100° C., so no partial evaporation of residual volatile compounds and moisture takes place while extruder is densifying the carbonaceous material.

In further advance, the present invention envisages the extruder type comprising of a compression zone preferably with an integrated curse and fine nibbler equipped with appropriate sieve, straining the agglomerated clumps of fed carbonaceous material, which turns and re-powders the compressed clumps back to powdered material again (called as nibbler zone) before the feeding material is being discharged to the discharge chute or directly into the so-called First Pressurized Vessel intermediary.

The present invention comprises a process for conveying of proper material for the partial oxidation in a pressurized reactors—in particular a gasification reactor—thereto the feeding material will be injected from the so called second pressurized vessel over at least one so called reactor-feeding-unit, which consists of a star valve, an so called injection line for injection of gaseous media ready for pneumatic conveying and a so called reactor feeding line for pneumatic transportation of bulk solid into that reactor. The star valve is preferably designated with a compartment in discharging position, so through that compartment the injection gaseous media will be exposed to the feeding bulk solid so that any pneumatic bulk solid conveying regime can be performed along the so called reactor-feeding-line which ends up at the inlet nozzle(s) of combustion chamber of gasification reactor, where the partial oxidation will be executed.

This particular part of the process, outlined in the above paragraph, can be inventively carried out without any reliance on the application of a specific extruder and is to be regarded as independent inherent part of the present invention (i.e. in a revamping of hitherto plant). Preferably the present invention includes also a feeding process in conjunction with an extruder in different kind and types.

In further particulate advantage of process, the process invention aims at to conveying the feeding material obtained downstream of an extruder from a so called first pressurized vessel over intermediary divert valve and slam shut off valve(s) optionally to one or more tubular drag conveyor(s) operating at elevated pressure which transport(s) the feeding material to the so called second pressurized vessel in sequel. The second pressurized vessel (named as “reactor-feeding-vessel”) shall be preferably installed close to the upper part of gasification reactor individually. The second pressurized vessel figures as reactor feeding vessel and is to be equipped with one, or a number of so called reactor-feeding-unit(s)—referred also to as splitter—in the lower compartment of that vessel. Each reactor-feeding-unit (splitter) is hereby consisting of a star valve, an injection line for a gaseous utility media and a reactor feeding line principally. The discharged feeding carbonaceous material from the star valve will be exposed to the injection gas and passes through the reactor-feeding-line by for instance the way of a pressurized pneumatic dense flow conveying or ultra-dense flow conveying into the adjacent gasification reactor.

In addition, the new process recognizes the circumstances for variable actual load of gasification reactor by the way of revolution controlled electric propulsion i.e. for electric actuator of the star valve, so that any desired plant load can be controlled over the upstream process controlled discharge arrangement of main atmospheric silo, LP conveyor, low pressure feeder vessel and the extruder loading to the second pressurized vessel. In the lower discharge compartment of the star valve a gaseous media consisting of saturated steam, superheated steam, natural gas, any other inert gas like nitrogen or CO2, hydrogen enriched purge gases from synthesis section of ammonia or methanol plant, purge gas of PSA (Pressure Swing Adsorber) of hydrogen purification section of plant, hydrogen or a blend of those gaseous media in any mixture ratio as so called carrier gas will be exposed for final entraining of carbonaceous material into the adjacent reactor by any pneumatic conveying mechanism.

In further advance, the present invention considers the entire feed conveying with Integrated Process Control System (IPCS), which comprises under gravimetric mass flow metering and control and/or additionally controlled by volumetric metering station(s), from the first subsection (for instance discharge device of low pressure hopper) in concert to each other, upto to any individual transportation devices in the upstream sections.

For instance, IPCS recognizes also the transportation from LP hopper (i.e. revolution controlled propulsion of low pressure screw conveyor, band conveyor or tubular drag conveyor, 4 as well as extruder unit 6) in concert to extruder mass throughput controlled by frequency-controlled of extruder's electric propulsion to the first pressurized vessel operating also in concert to the downstream sections (i.e. pressurized tubular drag conveyor's driving pace 10 up to second pressurized vessel, the rotation control of star valve propulsion 12, mass flow of the injection gases 13) in such a manner, that at any actual load situation of the reactor a minimal level in the vessels can be held up to any plant load accordingly.

In added advantage it shall be highlighted that the carbonaceous feeding material will be transferred continuously from the first pressurized vessel via one or more pressurized tubular-drag conveyor to the second pressurized vessel installed adjacent to the upper place of the reactor. The feeding carbonaceous bulk material from the second pressurized vessel will be entrained into the reactor via one or more so called reactor-feeding-unit (splitter), each one consisting of a star valve 12, injection line for carrier gas 13 and a reactor-feeding-line 14 for pneumatic conveying of material. Each reactor-feeding-unit can be put in operation either individually in turn or all reactor-feeding-units will be set for operation simultaneously according to the devoted actual load case of plant outlined above. The pneumatic injection via reactor-feeding-unit is designated in a manner that any desired pneumatic conveying regime (i.e. pressurized dense flow phase, pressurized ultra dense flow) can be performed in prior, before the feeding material enters the reaction chamber of gasification reactor.

The present invention comprises in addition the application of a proper sealing technique i.e. by the way of gas lubricated mechanical sealing ring for all rotating shafts (extruder shaft, tubular-drag conveyor driver as well deflecting shaft, star valve shaft) which are operating at low and/or elevated pressure. This measure allows the impervious sealing of the shaft to dust leakage. In added support to the gas lubricated mechanical sealing, the sealing ring itself can be equipped at the bearing side under prevailing pressure with an over-housing protecting shaft yoke, which shall be impinged with inert barrier gas eventually with dust release from yoke to a safe closed circuit.

This invention presents in further advance a feeding process for transferring of carbonaceous material subject to partial oxidation in a pressurized reactor, preferably a gasification reactor, thereby the material will be entrained by use of a carrier gas like saturated steam, inert gas, natural gas, any hydro carbonaceous gas, CO2, in particular superheated steam in such a way, that the carrier gas itself preferably participates in the chemical partial oxidation reactions deigned as an active reactant.

This part of the process in conjunction to a chemically reactive carrier gas application presents independently a solemn advantage of present invention for any kind of specific material conveying method without any reliance to the type of conveying regime and is to be regarded as an inherent part of the present invention.

Nevertheless the present process will be carried out in conjunction with an extruder along with one or more reactor feeding unit (splitter) according to aforementioned procedure.

This invention specifically comprises the high pressure continuous conveying of carbonaceous material at a pressure margin of 0.1 bara to 300 bare in concert with a pressure difference of 0.1 bar to 20 bara over the prevailing reactor pressure and a carbonaceous material with the conveying temperature of 5° C. to 100° C. will be exposed to a carrier gas and a pneumatic bulk solid conveying into the reactor will be executed by a specific pneumatic conveying ratio number in the margin of:

μ=0.1˜300 kg (product)/kg (carrier gas).

can be realized now duly, wherein the carrier gas is related to air by application of any other conveying carrier gas. The carrier gas (saturated steam, inert gas, hydro carbonaceous gaseous media, CO2, preferably super heated steam) itself takes place preferably as chemically reactant agent promoting the partial oxidation reactions in the reactor. In case of steam or superheated steam, the carrier gas heats up the bulk solid material with the initial conveying temperature of 5° to 100° C. up to the privileging carrier gas temperature along the path of Reactor-Feeder-Line. In case of application of superheated steam with the initial injection pressure of 0.1 to 20 bar over the privileging reactor pressure, the degree of superheating temperature can be vary from 0.1° to 200° C. over the associated saturation temperature of steam at the pressure level along the reactor-feeder-line.

In added advantage, the low pressure coal hopper deigned for intermediary storage of carbonaceous bulk powdered material is preferably equipped with such suitable discharge device (i.e. implemented oscillomator) for continuous dry transportation of feeding material so that any utilization of gaseous media supposed for upholding the bulk solid under steady movement (moving bed or fluidization bed) is not necessary anymore.

In particular the invention encompasses inventively a continuous process for conveying of dry coal powder and/or a blend of material subject to partial oxidation (i.e. blend of various kind of coal, petroleum coke, biomass in different types, circulating slag material, chemical additives termed as co-feed “catalyst” and eutectic promoting additives for slag, etc. in any mixture ratio) without imposing of fluidizing gaseous media for moving or fluidizing of carbonaceous material in low pressure hopper for intermediary storage—kept under inert gas media separately. The atmospheric low pressure hopper and other equipment will be kept under minimal inert gas pressure in order to oppress the ingress of air oxygen or moisture into the system. The intermediary storage is designated by implemented bulk solid discharge device (i.e. oscillomator) which transfers the feeding material to an appropriate further conveying device (i.e. screw conveyor, band conveyor or tubular-drag conveyor operating by gravimetric mass flow or volumetric flow control). The feeding material will be transported in continuo over an or a multitude number of extruder's funnel(s) to an or a number of extruder(s) eventually equipped with internal indirect cooling coils and jacket cooling compartment and/or additionally intercooling section. Along the compression zone of extruder the high pressure densification of the powdered material will be carried out up to a pressure level higher than the actual prevailing operation pressure of the gasification reactor. The first over pressure vessel downstream of the extrusion unit receives the re-powdered material either directly or over extruder's discharge funnel and transfers in continuo to the next pressurized transport equipment i.e. to one or a number of tubular-drag conveyor(s) up to the second pressurized vessel. All pressurized vessels and conveyor are to be operating under elevated pressure performed by gas cushion. The second pressurized vessel shall be installed adjacent to the gasification reactor in a close distance. The second pressurized vessel is designated with a or a number of so called reactor-feeding-unit (splitters), each one consisting of star valve, injection line for gaseous media (saturated steam, superheated steam, inert gas, CO2, natural gas or any blend of those gases in any volumetric ration) and a reactor-feeding-line. Shut-off and slam shut off valves are placed upstream of star valve (eventually inside of the second pressurized vessel), along the injection as well the reactor-feeding-line in pursuant to officinal local applicable Standards and Regulation. Along the reactor feeding line a pressurized pneumatic conveying takes place in any pneumatic conveying status (“regime” e.g. pressurized dense flow phase or pressurized ultra-dense flow phase) transferring the feeding material into the reaction chamber of the gasification reactor. The partial oxidation reactions take place in the reaction chamber of gasification reactor with other reactants like air, oxygen, natural gas, other higher gaseous hydrocarbons with or without liquid carbonaceous material (i.e. naphtha, oil, light-, middle fractions etc.). All other liquid media are to be conducted into the reactor by separate lines. The partial oxidation of all entered materials takes place under high temperature and high pressure producing row process gas (also termed improperly to raw syngas), predominantly consisting of CO and hydrogen ash and slag.

The invention considers the application of an extruder with two telltale characteristics. The extruder(s) is designated with indirect cooling jacket where the coolant media circulates for deflection of accruing heat as a result of friction along the compression zone. The implemented cooling can include also the indirect cooling of extruder shaft as well. By this measure any undesired evaporation of volatile or moisture compounds constituent in the feeding material can be avoided along the way of compression duly. By this measure all moisture/volatile compound will remain absorbed within the body of feeding material without causing the cavitations effect in the extrusion stage. The second characteristic feature of the extruder employed in the present invention relates to a nibbler, preferably integrated in the body of extruder at the end of compression zone or flanged on outlet nozzle of extruder upstream of the first pressurized vessel. The nibbler crumbles and re-powders the clumped and agglomerated material which grants the flowability of carbonaceous material after the densification stage without disturbing jam-up or plugging in the sequel downstream equipment.

The present invention comprises a process for continuous dry supply of carbonaceous material subject to partial oxidation in a pressurized reactor consisting of at least one low pressure hopper, one extruder with inlet and outlet funnel, vent of outlet chute back to LP hopper, extruders intermediary vent of void volume gas captured in the bulk solid, a first pressurized vessel, which optionally can be installed in common for a number of upstream extruders as well downstream tubular-drag conveyors. Along the compression zone of that extruder the densification of feeding material will be carried out up to a pressure over the prevailing reactor operation pressure and whereby the densified material will be discharged in the first pressurized vessel.

The present process invention includes in continuo systems for one of transportation processing outlined above. This process invention shall be illustrated with execution examples and described with enclosed figures as follows:

FIG. 1 A first exemplary application of the present invention and

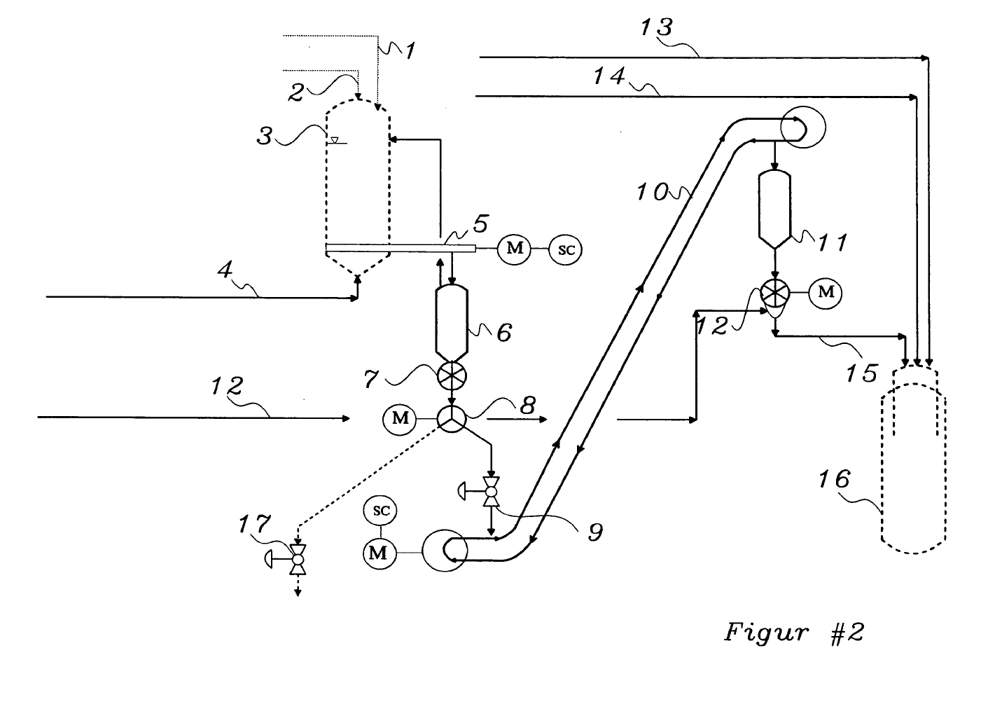

FIG. 2 A further exemplary application of the present process invention for upgrading of hitherto plants,

FIG. 3 Illustration of extruder's detail in conjunction with redundancy skid and regular start-up period as well as switching for duty/stand-by extruder skid while plant operative.

The invention illustrates inventively a process for continuous dry coal powder 1 and/or a blend of carbonaceous material (i.e. mixture of feeding material consisting of coal in various kind, petroleum coke, recirculation ash and chemical additives, termed as catalyst or co-feed 2 in any particulate blend ratio). The feed material will be converted via chemical partial oxidation reactions. The process distinguishes of a dry feeding without utilization of any fluidizing or moving gas to in the low pressure hopper 3. The low pressure hopper (day bin) in supposed for intermediary storage only and will be kept under minimal inert cushion gas (as a measure for precaution to egress of air oxygen). The low pressure hopper is equipped with a suitable integrated discharge mechanism (i.e. oscillomators 3a). The feeding material will be discharged and transferred via suitable conveying device 4 (i.e. screw conveyor, band conveyor or tubular drag conveyor) under gravimetric controlled or volumetric controlled operation to one or more extruder attributed to low pressure feeder vessel 5 installed upstream of one or more extruder(s) 6 with inlet funnel optionally with or without intense cooling circuit for indirect cooling of that extruder 6a. The feeding material as powdered, granulate, cursed bulk solid experiences in the compression zone of extruder unit a high pressure densification up to a pressure higher than the prevailing gasification reactor operation pressure and be discharged over extruder's outlet funnel in an intermediately first pressurized vessel 7.

If the installation place of reactor is far from the extruder unit, the feeding material will be transported inventory by the present invention to a second pressurized vessel through a pressurized conveyor, preferably tubular-drag conveyor.

The feeding material will be conveyed further from the first pressurized vessel 7 to a number of pressurized conveyor(s) 10 installed eventually in series (i.e. overpressure tubular drag conveyor or a number of overpressure tubular drag conveyors in serial installation if required by the installation arrangement). The feeding material will be transported to individually reactor attributed second pressurized vessel 11. The second pressurized vessel 11 is to be installed close to the upper part of gasification reactor 17. The second pressurized vessel 11 is specially equipped at the bottom with one or more reactor-feeding-unit, each one consisting of a star valve 12, injection line 13 and pneumatic conveying of that material via reactor feeder line 14. The injection line 13 meets the feeding material at the lower compartment of star valve 12 and carries the material along the short path of reactor feeder line 14 into the gasification reactor 17. Shut-off and slam shut off valves are performed for upstream star valve (eventually inside of the second pressurized vessel), along the injection as well the reactor-feeding-line according to the officinal Standards and Regulation, where the plant will be installed. The pneumatic conveying is accomplished via injection line 13 (by application of saturated steam, superheated steam, inert gas, CO2, natural gas, or any particulate blend of those gaseous media in any mixture ratio) forming any particulate conveying mechanism (i.e. Pressurized Dense Flow Phase, Pressurized Ultra-Dense Flow mechanism) up to the inlet nozzle(s) of reactor 17.

In the reaction chamber of gasification reactor the partial oxidation reactions take place with other reactants i.e. air, pure oxygen 16, other fuel gas 15, i.e. natural gas, gaseous hydrocarbons with/or without liquid precursors (i.e. naphtha, oil, light or media fractionates, etc.) 15 via individual separate lines. The reactants convert at high temperature and elevated pressure through a series of chemical reactions to process gas predominantly consisting of CO and H2, ash and slag.

The employed extruder 6 is distinguished with intense cooling system 6a that the arising heat resulted by intra-particulate friction during the compression can be diffracted indirectly via circulating coolant media. The circulating coolant media will be passed through the extruder jacket and/or eventually through the extruder shaft in added measure. The cooling is to be proceeding in a way, that a partial evaporation of violate moisture residual will be oppressed along the extrusion stage entirely. The cooling circuit secures the retention of moisture and volatile compounds along the way of extrusion that those compound can be retained in absorbed liquid aggregate of phase dully. Additionally the extruder 6 is distinguished with a nibbler section placed downstream of extruder or more preferably integrated at the end of compression zone in a manner that agglomerated chucky clumped, for instance made of coal powder will be crumbled and re-powdered by curse and fine straining of feeding material via that nibbler. The nibbler assures that only flowable powdered material can be obtained in the first pressurized vessel 7.

As a measure for provision of long-term availability of gasification plant and long-operation period of the coal feeding island, the present invention is able to perform redundancy for the first time in gasification technology. The process associated with redundant equipment can be preferably provided by the high pressure equipment deigned for pressure elevation i.e. extruder's low pressure feeder vessel 5, extruder 6, (eventually with first pressurized vessel 7, divert valve 8 and the slam shut off valve 9) which can be regarded as a pressure elevation unit (termed as “skid”). The redundancy refers to one duty skid while the other skid imposes as stand-by skid ready for operation at any time. The repair, maintenance and retrofitting outage is distinguished for out-of-operation skid by this measure so that i.e. the pressure release and discharge of pressurized equipment can be performed via separate relief and vent lines for gaseous and feeding material captured within the equipment through discharge valve 18 prior to inception of maintenance work.

This process considers inventively the application of a number of electric propulsion driving the shaft which is embedded in the pressurized equipment impinged with feeding material. Therefore it is imperative to include suitable sealing techniques deigned to work properly in order to perform sealing system impermeable to dust leakage. The present invention includes dust and inert gas sealing preferably by the way of labyrinth sealing ring impinged with barrier sealing gas (an inert gas) and/or more preferably the application of inert gas lubricated mechanical sealing ring. Optionally the shaft sealing mechanism can be protected by over housing sealing yoke which is separately impinged with inert barrier gas in added safety. That barrier gas along with the sealing gas can be purged out of yoke.

In added support to continuous operation of the plant even the pressurized tubular-drag conveyor (or a the series of pressurized tubular-drag conveyors) can be installed twice providing redundancy even though these equipment are devoted as robust and reliable equipment from operation and maintenance point of view. All other components are dedicated as well proven equipment in both the functionality as well the simplicity can be installed preferably in single unit.

This process encompasses inventively a minimum level of feeding material (hold up) in the low pressure Feeder Vessel 5, the First as well the Second Pressurized Vessel 7 and 11 while the plant island operative. This measure will be carried out by IPCS (Integrated Process Control System) and ensures a minimal lost of the pressurized cushion gas prevailing over the downwards free-flowing feeding material. By this measure for precaution, a minimum lost of cushion gas over the star valve in to the reactor can be performed. For this measure, the star valve will be equipped with frequency-controlled electric propulsion, whose rotation speed operates in concert to the material level prevailing in the Second Pressurized Vessel. Therefore the consumption of pressurizing cushion inert gas can be reduced at the minimum lost over the bulk solid void volume regardless of actual mass throughput at any plant load.

In order to grant a smooth continuous operation the default plant load will be set in to IPCS (the mass flow value). The devoted mass flow rate could be set up as a fix value, invoked by plant operator manually or can be determined via gradually load-gradient in an automatic manner, i.e. while plant ramps up or is to be reduced in load or the shut down shall be entered. In any plant load, for instance the frequency-driven electric propulsion of equipment controls the discharge rate from LP hopper 3 and 3a; with flow or weight measurement in LP hopper 3, LP Feeder Vessel 5 over LP conveyor 4, the mass throughput through the extruder 6 and all other equipment in sequel via IPCS architecture. The IPCS will also define the tubular-drag conveyor operation pace 10 (either continuously speed rate or in a number of staggered speeds), up to level control in the Second Pressurized Vessel by rotation speed of star valve actuator.

The IPCS shall conduct also the initiate natural gas or nitrogen injection gas while the plant is to be commissioned if steam from steam recovery section of the plant or other sources are still not available. The IPCS management conducts the gentle change for replacing of initiate natural gas, N2 or CO2 to the steam injection mode for normal operation during the plant start-up period and vice versa during the shut-down period as well as flushing period additionally.

In the second pressurized vessel 11, the components of star valve 12, injection line 13 and the reactor feeding line 14 build up together a feeding-unit (termed also as splitter unit). Depending on the kind of gasification reactor and actual load case of the gasification reactor, the second pressurized 11 can be equipped with one or more feeding-unit(s).

By having of a number of reactor-feeding-lines 14, inventively it is now possible, that the gasification reactor can be set in operation under variable load case according to actual desired plant load. In particular this versatility allows a significant flexibility while the plant is to be operative in start-up/shut-down case, under lower desired load case and/or launches after regular shut down (from Cold Stage) or even after unexpected outages by a smooth controlled manner. It is in fact any re-start or start-up can be carried out gently, i.e. after a short unplanned outage or a re-start after Hot-Stand-By of the plant. Any kind of aforementioned start-up can be carried out smoothly and quickly by injection of natural gas as initiative injection gas. This is a special peculiarity of present invention which allows fulfilling of stringent Air Permit Standards while plant is to set operative during start-up/shut-down.

It is also possible by the present invention to feed various kind of material in a blend of different precursors (i.e. in fine, curse, crushed, shredded etc.) over the second pressurized vessel 11, which has passed the equipment 3 to 10 in prior with the main constituent or separately devoted equipment 3 to 10 up to common second pressurized vessel. All those material or a blend of them can be entered to the reactor through the reactor-feeding-units.

By this measure, depending on the actual mass flow rate of injection gas 13 (most preferably with superheated steam) and on the actual mass flow rate of carbonaceous material any variably different type of pneumatic bulk solid conveying mechanism (regime) i.e. Dilute Phase Conveying, Dense Flow Conveying with by-pass, Dense Phase Pressure Conveying or Ultra-Dense Phase Pressure Conveying can be realized easily, how ever the latter regime is most desirable regime. The Dense Phase Pressure Conveying of this invention comprises a specific mass flow loading index of 0.1 to 300 kg carbonaceous material to kg conveying injection gas with a pressure difference margin of 0.1 to 20 bar between the pressure of the second pressurized vessel and the actual prevailing gasification operation pressure.

In contrast to state-of-the-art chemically inert gas injection (with nitrogen or even chemically less reactive CO2) the present invention opens the opportunity to convey the carbonaceous material preferably with superheated steam which itself promotes the extent of chemical partial oxidation reactions as an active reactants. This fact, along with flexible mass flow conveying rate by the way of reactor-feeder-units in any pneumatic conveying mechanism enables the variable set point vote of the plant. These masseurs have been not possible via inert gas injection (nitrogen or CO2) which reduce the extent of those chemical reaction with adverse impact.

In case, the excess steam carried into the reactor via conveying mechanism can easily removed from the process either in the quench section of the reactor or by the way of condensation downstream of the reactor. The adverse influence of inert gaseous media (nitrogen or CO2) which burdens unnecessarily the reactor as well the reactor downstream plant sections will be undoing by present high pressure feed conveying process.

Exemplary Embodiment of the Invention with Optionally Respect to Redundancy

In light of start up of the plant feeding island as well the aforementioned redundancy, the FIG. 3 might illustrate the process inventively by following exemplary description.

The preparation and control of requisitions measure prior to ramp up the plant will be checked and permits the start up via IPCS. The system downstream of First Pressurized Vessel (or in case of operation without HP tubular drag conveyor, the Second Pressurized Vessel) is pressurized up to the operation pressure of feeding system, preferably with inert gas or any other appropriate gaseous media i.e. CO2, else. The slam shut valves/shut off valve 9, FIG. 1, 2 or 6f in FIG. 3 are set in CLOSED position. The availability of boundary system (i.e. minimal coal level in LP hopper, cushion gas pressure, lubrication sealing gas pressure, cooling circuit, etc.) releases the plant operability prior to start-up introduction. The isolation valve(s) between HP Discharge Vessel 11 and the star valves (not depicted at ease of overview) are also in CLOSED position while the heat up and inception of reactor pressurization and downstream system takes place through rotating star valves and the injection line impinged preferably with natural gas as initial carrier gas according to the set pneumatic conveying mechanism for this period.

With inception of pressure equalization via inert gas at the dedicated operation pressure between the HP Vessels; the HP tubular drag conveyor can start for operation. IPCS invokes the minimal plant load i.e. 5% once the system RELEASES for operation mode. The hopper's discharge system starts in concert with gravimetric controlled flow meters, so the feeding materials will be transferred via LP conveyor and LP Feeder Vessel to extruder's inlet chute.

The upcoming material at inlet chute releases the operation of duty extruder's propulsion by minimum rotation speed (FIG. 3) along with the nibbler propulsion. After passing a lag time with commencement of extruder's shaft rotation; the extruder skid is impinged with forward moving densified material, so the extruder acts as self sealing system towards downstream pressurized sections. The pressurization of First HP Vessel 7 (in case of without redundancy or the outlet chute 6d with redundant extruder skid) starts after that lag time. The material will be captured intermediary in the 7 or 6d at this time period. As soon as the pressure equalization is approached, the shut off valves open the way to downstream equipment.

By reaching a minimal level in the HP Vessel (i.e. 7)—equipped with Reactor-Feeding-Units—the level measurement releases the opening of isolation valve(s) via IPCS, so the IPCS controls the discharge pace of feeding material through the rotation speed of star valve actuator(s) simultaneously. The rotation of star valve will be operative by keeping the dedicated mass throughput at the bulk solid level in the above HP vessel. With commencement of discharge material to the lower compartment of star valve(s); the injection gas entrains the material according to separate SUBROUTINE loop of IPCS with selected injection gas and pneumatic conveying mechanism into the reactor.

The gradually load increase can be set up manually by operator or via different IPCS staggered program at any desired pace gradient up to the maximum load case of plant. As far proper steam generation of the plant is intact, the smooth transition of initial injection gas to the superheated steam will be conducted by IPCS program mode. The planned shut down of the plant will be carried out vice versa to the start up cycle.

Respectively any trip of plant leads to interruption of feeding island so a controlled out-of-operation mode has to be set for plant safety. In outage cases the isolation valve above the star valve(s), shut off valves downstream of extruder, pressure equalizing valves and cushion gas valves will be set in CLOSED position immediately. The CLOSED valve stem position of shut off, valves the extruder/nibbler/HP tubular drag conveyor propulsion along with discharge system of LP hopper/conveyor stops operation, while smooth pressure relief of the extruder's discharge chute to LP hopper takes place. Simultaneously the flushing valve for nitrogen OPENS in the injection line, flushing the injection line, star valve and Reactor-Feeding-Line for certain short time of 0.1 to couple of seconds only, so the material along this way will be flashed into the reactor before the slam shut off valves in Reactor-Feeding-Line and Injection Line fall in CLOSED position.

While the invention has been described in connection with what is presently considered to be the most practical and preferred embodiments, it is to be understood that the invention is not to be limited to the disclosed embodiments; but on the contrary, is intended to cover various modifications and equivalent arrangements, particularly in connection with international Standards and Regulations, included within the spirit and scope of the appended claims.

Some of peculiar advantages of present process invention can be illustrated in following specimen applications. The pneumatic conveying mechanism for transport (along the reactor-feeding-line) can be set up according to actual gravimetrically measured mass flow rate at the low pressure equipment 4 and 5 and the actual mass flow of injection carrier gas by the way of gas control valve 13 (in case of a blend of injection gases by the way of individually flow control valves i.e. each one for inert gas, natural gas, etc.).

The above mentioned measure inventively allows this feeding process to fulfill any plant load flexibly. Through this proceeding there can be realized plant load i.e. beginning with i.e. 5% at the start-up period up gently smooth to maximal nominal load and/or up to 105% to 110% in peak case easily.

One of essential peculiarity of present invention is focused on to perform a feed conveying system which works under dry condition of carbonaceous material. The most common feeding process of carbonaceous material carried out as a coal suspension (Slurry Feed)—under addition of water as carrier media for coal—is not necessary any more. Thereby the entrainment of water with its adverse reaction to gasification reactor performance will be undoing in future.

As a result of the latter two advantages, those types of gasification reactors can be upgraded from their design point of view in future. In similar manner, the present invention opens the viable way for upgrading and retrofitting of hitherto reactors to be fed with this coal feeding process, which is currently in operation with coal slurry. Therefore, depending on the gasification reactor, an enhancement of plant capacity in the margin of 10% to 15% can be attained for hitherto plants.

In similar way, the present invention opens a viable way for upgrading of state-of-the-art dry feeding. Depending on the gasification reactor, an enhancement of plant capacity in the margin of 5% to 10% can be attained for hitherto plants. In addition, the huge extent of equipment deployed for that process pertaining to coal hoppers and coal handling under fluidized or moving bed accompanied with intricate gas supplying will be not necessary any more. Solely the large arduous extent required for mass flow of inert gas under high pressure condition for fluidizing and moving bed condition in those hoppers requires a high consumption of energy (compression energy), cooling water regarding to operation and maintenance expenditures as well high investment costs for facilitation.

As outlined above—the injected superheated steam works as carries gas 13—promotes at one part the extent of chemical partial oxidation reactions converting the entrained coal to desired process gas products (hydrogen and CO), while the unconverted part of that steam can be easily captured and removed from process gas either in the reactor integrated quench subsection or in a reactor downstream condensation stage (i.e. row process gas cleaning section and the CO2 removal plant island). In contrast to the state-of-the-art system with the inert conveying carrier gas, this part of invention allows now, that the reactor downstream equipment and plant sections can be designed in a smaller size leading to lower investment cost.

In case, the prepared process gas (hydrogen and CO) is intended to be used for manufacturing of chemical products, the present coal conveying invention with superheated steam leads to extraordinary benefits. The present feeding process renders the potential, that the partial pressure of chemically active constituents (hydrogen and CO) for further conversion of CO in the catalytic water shift reactor will not be constrained by present of inert gas (i.e. Nitrogen or CO2) unnecessarily. Keeping the partial pressure of active intermediary reactants (hydrogen and CO) at higher level takes beneficial advantages in design and operation efficiency of the involved catalytic reactors, if the process gas is aimed at to be converted to ammonia, methanol, substituted natural gas (SNG) and gasoline under implementation of Fischer Tropsch synthesis for instance. Therefore the present invention contributes also to cost reduction or enhancement of synthesis efficiency of those chemical plant section, in particular for new or existing ammonia and methanol plants.

It should be highlighted, that the present process invention under deletion of inert conveying carrier gas leads to a relief of the syngas compressor of those plant (in particular methanol syngas compressor) in addition.

In conjunction of enhancement of synthesis section of aforementioned chemical plants, it should be also the mass flow of purge gas taken into account. Since the present process invention doesn't apply inert conveying carrier gas those plant (ammonia, methanol, Fischer Tropsch, MTG Methanol To Gasoline) a reduction of purge gas from those synthesis section can be achieved too. This factor contributes to the enhancement of synthesis section of those plants in addition.

As a result of deletion of CO2 as conveying gas, the prepared process gas obtained by implementation of present invention, is not burden with additional CO2 any more. Therefore, the present invention provides remedy for CO2 sequestration if the prepared process gas is to be applied for power generation by a gas turbine. In this case the scope of Acid Gas Removal plant island for the CO2 removal and sequestration will be reduced in size, footprint and operation costs. The present process provides inventively by the same token essentially lower investment volume, remedies in scope of maintenance etc. which underscores the entire gasification plant economically.

As outlined above, there are currently a great number of gasification plants with either the obsolete coal slurry feeding system via pump into the reactor or with the failure prone lock hopper dry feeding system operative. The lock hopper system imposes a lot of complicated issues associated with the hoppers as well the intricate inert gas handling and conveying media.

The present process addresses a workable system for those plants, deigned to operate property for the plants in future as well as for hitherto plants. In following the application of this process for the existing plants should be illustrated with specimen FIG. 2 inventively.

In the plants with the dry feeding system according to the state-of-the-art, there is a pressurized Surge Vessel (FIG. 2, element 3) keeping the feeding material in moving and/or fluidizing bed operation regime.

The application of present invention could be retrofitted exemplary in a manner, that the feeding material can be extracted via discharge equipment (i.e. gyro-rotating screw conveyor 5 and an added gas commuting line between first pressurized vessel 6 and the pressurized hopper 3 for pressure equalization back to pressurized hopper 3). That screw conveyor 5 conveys the bulk solid into the first pressurized vessel 6. From the first pressurized vessel 6 on the new process can be integrated totally. All aforementioned advantages pertaining to enhancement of reactor performance because of absence of inert conveying gas can be attained inventively according to this process.

In addition, any single component individually or a compound of individual elements of this invention can be implemented inventively in retrofitting project to a gasification plant.

List of Components in FIG. 1

| | |
|---|---|
| 1 | Powdered coal, coal pellets, petcock, etc. |
| 2 | Dry pulverized co-feed, biomass, additives, etc. |
| 3 | Atmospheric main hopper |
| 3a | Discharge device of main hopper i.e. oscillomators |
| 4 | Feed conveyor i.e. screw or tube-drag conveyor |
| 5 | Extruder's funnel |
| 6 | Extruder |
| 6a | Cooling circuit of extruder |
| 7 | First Pressurized Vessel optionally with vent system |
| 8 | Diverter valve |
| 9 | Slam shut off valve |
| 10 | HP Tubular drag conveyor |
| 11 | Second Pressurized Vessel |
| 12 | Star valve with leak gas, leak gas/dust collector and injection |
| | compartment for pneumatic conveying |
| 13 | Pneumatic injection gas line for superheated steam, saturated |
| | steam, natural gas or other conveying gases |
| 14 | Reactor-Feeding line |
| 15 | Supplementary gasification line (natural gas, naphtha vapour, off |
| | gases or other carbonaceous gases) |
| 16 | Oxidizing gas (i.e. air, pure oxygen) |
| 17 | Gasification reactor |
| 18 | Emergency discharge line of feed i.e. for maintenance or during a |
| | trip case |

List of Components in FIG. 2

| | |
|---|---|
| 1 | Powdered coal, coal pellets, petcock, etc. |
| 2 | Dry pulverized co-feed, biomass, additives, etc. |
| 3 | HP surge hopper (i.e. Feeder Vessel in Lock-Hopper or PWR |
| | process) |
| 4 | Optionally discharge device for Feeder Vessel |
| 5 | Feed conveyor i.e. screw or tube-chain-disc conveyor, discharge |
| | device for coal with gas bypass (i.e. screw band conveyor with |
| | revolution control electric propulsion) |
| 6 | First Pressurized Vessel with gas equalization line back to |
| | Feeder Vessel |
| 7 | Discharge device (i.e. star valve) |
| 8 | Diverter valve |
| 9 | Slam shut off valve |
| 10 | HP Tubular drag conveyor |
| 11 | Second Pressurized Vessel |
| 12 | Star valve with leak gas, leak gas/dust collector and injection |
| | compartment for pneumatic conveying and pneumatic injection gas |
| | line for superheated steam, saturated steam, natural gas or other |
| | conveying gases |
| 13 | Supplementary gasification line (natural gas, oxygen, naphtha |
| | vapour, off gases or other carbonaceous gases) |
| 14 | Oxidizing gas (i.e. air, pure oxygen) |
| 15 | Reactor-Feeding line |
| 16 | Gasification reactor |
| 17 | Emergency discharge line of feed i.e. for maintenance or during a |
| | trip case |

List of Components in FIG. 3

| | |
|---|---|
| 6 | Extruder with rotation control electric propulsion and inert |
| | gas-lubricated mechanical sealing ring for shaft |
| 6a | Intense cooling circuit for housing and shaft |
| 6b | Nibbler, optionally with separate rotation control electric |
| | propulsion |
| 6c | Extruder's inlet chute |
| 6d | Extruder's outlet chute |
| 6e | Initial pressirization inert gas for start-up of extruder |
| | operation |
| 6f | Shut-off valves upstream of high pressure sections of process |
| 6g | Vent of outlet chute back to LP bin |
| 7 | 1. Pressurized Vessel (acc. to FIG. #1 or #6 acc. to FIG. #2) |
| 11 | 2. Pressurized Vessel (in case of installation without HP |
| | tubular-drag conveyor) |

1. Process for continuous dry conveying of carbonaceous precursor for partial oxidation for supplying into pressurized reactor(s), in particular a gasification reactor, whereby that material will be taken off from an atmospheric hopper operating under inert gaseous media and will be fed at least to a extruder, wherein along the compression zone of extruder the densification of that material will be carried out up to a pressure higher than the prevailing actual operation pressure of that pressurized reactor(s).

2. The process according to claim 1, wherein the accruing friction and compression heat will be deflected from the passing material in the extruder with cooling system, which is designated to oppress the vaporization of moisture and/or volatile constituents of that material along the compression zone of that extruder, wherefore the cooling will be carried out, preferably via an appropriate coolant over the jacket of extruder and/or additionally through the shaft, so the final discharge temperature of densifying carbonaceous material within the extruder will be kept in the margin of 9° F. (5° C.) to maximal 180° F. (100° C.), more preferably between 35° F. (20° C.) and maximal 180° F. (100° C.).

3. The process according to one of the above claims, wherein the feeding material passing through the compression zone of extruder will be crumbled down from agglomerated chucky-clumped pieces back to free-flowing, more preferably powdered or granulate form, preferably by use of nibbler—whereby preferably that nibbler is equipped with fine and curse strain—which is preferably integrated in the body of extruder downstream of compression zone or flanged add-on at the outlet nozzle of extruder or installed separately between the extruder's outlet nozzle and extruder's discharge chute upstream of the so called First Pressurized Vessel.

4. The process according to one of the above claims, wherein the feeding material in any free-flowing form, shape and particle distribution containing a residual moisture and or volatile constituents in the range of 0.1 to 25% by weight, more preferably in the range of 0.1 to 10% by weight, comprises primarily dry coal dust and also other carbonaceous precursors, preferably coal powder, biomass powder, granulate, petcoke, residual of refinery, friable waste textile, fine shredded waste PP, PVC, rugs, plastics, additives for chemical effects e.g. slag eutectic promoting constituents, catalysts, etc. solely or in a blend thereof in any blend ratio, will be fed to the extruder.

5. Process according to one of the above claims wherein the feeding material preferably obtained from upstream milling and dryer stations will be transferred via an appropriate transferring device, preferably via screw conveyor, band conveyor or a tubular-drag conveyor to at least one extruder's Feeder Vessel or more preferably to the inlet chute of extruder directly.

6. Process according to of one of the above claims wherein the carbonaceous material will be densified by at least one extruder to a outlet pressure of 1.45 psi to 4635 psi (0.1 to 300 brag), or more preferably 1.45 psi to 1500 psi (0,1 bis 100 barü) so the extruder's final discharge pressure into the extruder's discharge chute and/or discharge vessel in a manner that all extruder's downstream conveying equipment will be operative in the range of 1.45 to 300 psi (0.1 to 20 brag) over the privileging reactor pressure.

7. Process according to one the aforementioned claims wherein the pressurized bulk solid material collected in a pressurized vessel, will be preferably transported pneumatically via Reactor-Feeding-Line in concert to any pneumatic conveying mechanism, for instance dilute flow, pressurized dense flow phase, more preferably via ultra-dense flow phase, into that reactor, whereby the pressurized vessel is equipped with at least one Reactor-Feeding-Unit—termed also to Splitter—consisting individually with a characteristic star valve with an injection compartment, an Injection-Line and a Reactor-Feeding-Line.

8. The process in accordance to claim 7 wherein the feeding material from the extruder will be discharged preferably over the discharge chute through divert valve and/or slam shut off valve(s) into a first pressurized vessel, whereby the feeding material from the first pressurized vessel can be more preferably transported further via a or a number pressurized conveying device(s) in series of appropriate conveyor type—e.g. pressurized tubular-drag conveyor—to that second pressurized vessel, wherefrom the material will be transferred by at least one Reactor-Feeding-Unit to the reactor.

9. The process in accordance to claim 7 and 8 wherein the star valve will be equipped with a rotation control propulsion actuator—preferably a magnet-clutched electric propulsion impervious to dust leaking—which operates in concert to the actual reactor load case dedicated preferably according to the entering flow rate of material from the low pressure hopper to low pressure feeder vessel and extruder's throughput flow rate, in a way, that the star valve takes off the feeding material from the upper vessel, preferably the second pressurized vessel, and displaces that by rotation into the lower injection compartment, so that the material can be exposed to an injection gas flow, consisting of saturated steam, superheated steam, natural gas, an inert gas like N2 or CO2, hydrogen enriched purge gases from synthesis section of ammonia or methanol plant, purge gas of PSA (Pressure Swing Adsorber) of hydrogen purification section of plant, hydrogen or a blend of those gaseous media in any blend ratio and the precursors will be transferred in to the reactor in accordance to any pneumatic conveying mechanism.

10. Process according to one the aforementioned claims wherein the bulk solid feeding proceeds preferably by at least one gravimetric metering station and/or volumetric bulk density measurement(s) accomplished supplementary with correcting and calibration measures e.g. gravimetric measurement of low pressure hopper, online-C analyzer(s) and online sampling device(s) in added support to telemetries and measurements, which control the propulsion(s) for dedicated flow rate, in particular by rotation control of electric propulsions of first low pressure conveyer in concert to all downstream equipment so that in the first and second pressurized vessel a minimal level of bulk solid will be held up dully e.g. the propulsion of extruder takes off material from low pressure Feeder Vessel in a manner that always a minimal level of bulk solid is held up there, or the level of material in vessel controls the rotation speed of star valve), albeit of any plant load case in the range of 1% to 100%, more preferably from 5% to 100% can be realized accordingly.

11. Process according to one the aforementioned claims wherein the sealing system for all rotating shaft of equipment operating at elevated pressure, e.g. extruder's shaft, tubular-drag driving shaft also deflecting ax and the shaft of low pressure conveyor will be driven either by hermetically magnetic-clutched electric propulsion—e.g. actuator of star valves—and/or the shafts are equipped with imbedded labyrinth sealing ring impinged with inert barrier gas or more preferably the shafts are equipped with mechanical sealing ring with integrated inert gas lubrication, whereby preferably the sealing ring is protected by shaft-joke, which will be impinged with inert barrier gas and preferably is set inherently within the equipment in added supporting measure, applicable e.g. for extruder, tubular-drag conveyor driving also deflecting shaft, etc.

12. Process according to one of the aforementioned claims wherein the transferring bulk solid final pressure will be in a margin of 1.45 psi to 4365 psi (0.1 to 300 bar g), more preferably in the range of 1.45 psi to 1465 psi (0.1 to 100 brag) operating by a pressure difference of 1.45 to 300 psi (0.1 to 20 bar) over the prevailing operation pressure of the gasification reactor keeping within transferring temperature of 35° F. to 180° F. (20° C. to 100° C.) upstream of Reactor-Feeding-Unit before the bulk solid will be exposed to the injection conveying gas, whereby the loading ratio of pneumatic conveying will be in a the range of 0.1 to 300 kg (material) per kg (air or gas), more preferably in the range of 0.1 to 50 kg (material) per kg (air or gas) in conform with the actual pneumatic conveying mechanism.

13. Process according to one of the aforementioned claims wherein the feeding material will be exposed with an injection gaseous media e.g. saturated steam, inert gas, natural gas, hydrocarbons, CO2 or more preferably superheated steam deigned as carrier gas for formation of any pneumatic conveying mechanism, so that the feeding process is applicable to any kind of gasification reactors, preferably circulating fluidized reactor, fluidized reactor, moving bed reactor or entrained reactor, whereby advantageously those gaseous injection media—solely or in a blend—will be preferred, which contribute(s) as promoting reactant for the partial oxidation reactions, preferably superheated steam will be injected heating up the feeding material with a degree of superheating from 0° F. up to 400° F. (0° up to 200° C.) over the corresponding saturation pressure of steam at the work pressure of 1.45 psi to 4365 psi (0.1 to 300 bar g) in concert to claim 12.

14. Process preferably according to one of the aforementioned claims whereby in a atmospheric intermediary hopper, more preferably in the low pressure hopper under inert cushion gas an integrated discharge device is envisaged, e.g. oscillomators, which allows the continuous dry proceeding without utilization of any fluidizing or moving inert gaseous media, preferably in a manner that the intermediary hopper operation will be carried out by mass flow control system via that discharge device to a low pressure feeder vessel upstream of the extruder(s).

15. System for continuous dry feeding of carbonaceous material subject to partial oxidation reactions in a pressurized reactor preferably according to one of the aforementioned claims, wherein by employing of at least a low pressure hopper, an extruder, a first pressurized vessel, the feeding material from that low pressure hopper will be fed to the extruder, where the material along the compression zone of that extruder will be densified up to pressure higher that the prevailing reactor pressure and then be transported to that first pressurized vessel.

16. System for continuous dry feeding of carbonaceous precursor subject to chemical reactions in a pressurized reactor preferably according to one of the aforementioned claims wherein the process will be employed by at least a low pressure hopper, an extruder with nibbler and inlet and outlet chutes, a pressurized vessel equipped with a or a number of Reactor-Feeding-Unit(s) so that the feeding process to the reactor will be performed from that pressurized vessel via conveying device e.g. screw conveyor operating under barrier gas to that reactor, preferably to a moving bed gasification reactor.

17. System for continuous dry feeding of carbonaceous precursor subject to chemical reactions in a pressurized reactor wherein the process will be preferably employed in the hitherto plants in on-side of pressurized surge vessel, capturing the pressurized carbonaceous precursors in a way, that the carbonaceous material will be derived from the surge vessel without gaseous media through a gas balancing line and/or via an appropriate conveyor out of that surge vessel so the discharged material will be entered in a pressurized vessel, wherefrom the present process according to one of the aforementioned claims will be implemented.

18. System, so called Extruder Skid, according to the claims 2, 3, 10 and 11 for densification of carbonaceous dry material at high pressure—more preferably carried out with redundancy—comprising according to FIG. 3:
a) Extruder preferably with rotation control electric propulsion and preferably inert gas-lubricated mechanical sealing ring for it shaft
b) Wherein the extruder is designated with single shaft, multi-shaft with/or multi-counter shaft in cylindrical or conical shaft shape with low pressure intake section, high pressure densification zone by way of compression of bulk solid material—preferably without heating and melting zone—will be incorporated in that extruder skid
c) Intense cooling circuit with coolant or cooling water for housing and shaft
d) Nibbler—optionally with separate rotation control electric propulsion—preferably directly attached at the end of extrusion's compression zone, which preferably grants to re-obtain free flowing powdered material.

19. System related to the Extruder Skid according to claim 18, further comprising:
a) That the Extruder's inlet chute operating under normal pressure and impinged by inert cushion gas as a receiving assembly for free flowing dry material, preferably as an assembly under mass flow control,
b) Extruder(s) preferably under redundant installation—more preferably with outlet chute as pressurized compartment—under normal operation mode with two vertically arranged valves, preferably two ball valves (as slam shut-off valves) at discharge part of that outlet chute, which isolate the pressurized section from the LP section physically safe,
c) Initial pressurization with inert gas to outlet chute and extruder prior to start-up of extruder skid operation,
d) Depressurization and vent of outlet chute back to LP bin, while extruder is out of operation or acts as stand-by equipment,
e) A First Pressurized Vessel (acc. To FIG. 1 or 6 acc. To FIG. 2), this can isolate the reactor from the feeding section physically in accordance with pertinent Regulation, Safety Measures and Installation Standards.
f) More preferably with a Second Pressurized Vessel (in case of installation without HP tubular-drag conveyor), which isolates the reactor from the feeding section physically in accordance to pertinent Regulation, Safety Measures and Standards in added measure.
